(19) United States
(12) Patent Application Publication
(10) Pub. No.: US 2026/0196180 A1
(43) Pub. Date: Jul. 9, 2026

(54) DATA DRIVING DEVICE AND DISPLAY DEVICE INCLUDING SAME

(71) Applicant: LX Semicon Co., Ltd., Daejeon (KR)

(72) Inventors: Sang Duk YU, Daejeon (KR); Won Youn KIM, Daejeon (KR); Sung Dae YEO, Daejeon (KR); Mun Seok KANG, Daejeon (KR); Kyeong Yun PARK, Daejeon (KR)

(73) Assignee: LX Semicon Co., Ltd., Daejeon (KR)

(21) Appl. No.: 19/442,793

(22) Filed: Jan. 7, 2026

(30) Foreign Application Priority Data
Jan. 8, 2025 (KR) 10-2025-0002961

(51) Int. Cl. G09G 3/3275

(52) U.S. Cl. CPC G09G 3/3275; G09G 2300/0814; G09G 2310/0289; G09G 2320/0233; G09G 2320/0271

(57) ABSTRACT

A data driving device for driving a display panel includes a source data latch configured to latch image data and to output first data, a level shifter configured to receive the first data from the source data latch and to convert a level of the first data to generate second data, a decoder configured to separate the second data transmitted from the level shifter into upper bits and lower bits, a gamma block configured to generate gray scale data, and a source amplifier configured to amplify data output from the decoder and to output the amplified data to the display panel, wherein the decoder includes a data masking combination logic configured to control the lower bits.

This application claims the benefit of Korean Patent Application No. 10-2025-0002961, filed on Jan. 8, 2025, which is hereby incorporated by reference as if fully set forth herein.

### BACKGROUND OF THE DISCLOSURE

### Field of the Disclosure

The present disclosure relates to a data driving device and a display device including the same.

### Discussion of the Related Art

In current display technology, accurate and rapid processing of pixel-level gray scale data is crucial for achieving high resolution and high refresh rates. In particular, signal stability in an interpolation gray scale range of gray scale data, which determines the image quality of a display, significantly impacts display quality.

Existing display driver circuits fail to effectively address issues such as slew rate deviation, gray scale inversion, and signal distortion-induced defects that occur during the initial transient state (slewing time) in gray scale data processing. These issues are exacerbated by differences in load conditions between edge channels and center channels of a display, further limiting signal stabilization in a high-speed environment.

In view of the above technical background, the present disclosure aims to solve the problem of signal distortion occurring in the interpolation gray scale range and to implement stable and uniform display quality even in a high-speed environment.

### Summary of the Disclosure

The present disclosure primarily addresses the problem of display image quality degradation caused by a combination of slew rate deviation and gray scale inversion. In particular, an aspect of the present disclosure is to provide a technical solution capable of providing clear and consistent screen quality even in high-resolution and high-frame rate environments.

The technical aspect to be achieved by the present disclosure is not limited to those mentioned above, and other technical aspects not mentioned above will be readily apparent to those skilled in the art from the description below.

To achieve these aspects and other advantages and in accordance with the purpose of the present disclosure, as embodied and broadly described herein, a data driving device for driving a display panel includes a source data latch configured to latch first data, a level shifter configured to receive the first data from the source data latch and to convert a level of the first data to generate second data, a decoder configured to separate the second data transmitted from the level shifter into upper bits and lower bits, a gamma block configured to generate gray scale data, and a source amplifier configured to amplify data output from the decoder and to output the amplified data to the display panel, wherein the decoder includes a data masking combination logic configured to control the lower bits.

In at least one embodiment of the present disclosure, the source data latch may include a SLON signal generator, and the SLON signal generator may generate a data masking pulse signal.

In at least one embodiment of the present disclosure, the lower bits may include interpolation gray scale bits.

In at least one embodiment of the present disclosure, the data masking combination logic may control the lower bits through an AND gate.

In at least one embodiment of the present disclosure, the AND gate may generate modified lower bits by combining the lower bits and the data masking pulse signal.

In at least one embodiment of the present disclosure, the source data latch may output third data for a first time, and the first time may include a slewing time.

In at least one embodiment of the present disclosure, the source data latch may output fourth data for a second time, and the second time may include a settling time.

In at least one embodiment of the present disclosure, the data masking combination logic may output at least one of original R, G, or B data for the second time.

In at least one embodiment of the present disclosure, the third data may include at least one of RSL, GSL, or BSL, and the RSL, GSL, and BSL may correspond to red, green, and blue data, respectively and include data generated by combining the upper bits and the modified lower bits.

In at least one embodiment of the present disclosure, the fourth data may include at least one of R_Data[n], G_Data[n], or B_Data[n], and R_Data[n], G_Data[n], and B_Data[n] may correspond to the red, green, and blue data, respectively, and include data (original data) obtained by restoring the modified lower bits.

In at least one embodiment of the present disclosure, the SLON signal generator may set a pulse width of the data masking pulse signal to a range of 25 ns to 400 ns, and adjust the pulse width according to output of the red, green, and blue data.

In at least one embodiment of the present disclosure, the data driving device may further include a slew booster circuit configured to supply additional current to the source amplifier to compensate for a slew rate deviation of an edge channel.

In another aspect of the present disclosure, a display device includes a data driving device including a source data latch configured to latch image data and to output first data, a level shifter configured to receive the first data from the source data latch and to convert a level of the first data to generate second data, a decoder configured to separate the second data transmitted from the level shifter into upper bits and lower bits, a gamma block configured to generate gray scale data, and a source amplifier configured to amplify data output from the decoder and to output the amplified data to the display panel, wherein the decoder includes a data masking combination logic configured to control the lower bits.

It is to be understood that both the foregoing general description and the following detailed description of the present disclosure are exemplary and explanatory and are intended to provide further explanation of the present disclosure as claimed.

### BRIEF DESCRIPTION OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a diagram illustrating a display device configuration according to an embodiment of the present disclosure;

FIG. 2 is a diagram illustrating a data driving device configuration according to an embodiment of the present disclosure;

FIG. 3 is a diagram illustrating data masking combination logic according to an embodiment of the present disclosure;

FIG. 4 is a timing diagram of a data driving device to which the data masking combination logic according to an embodiment of the present disclosure is applied; and

FIG. 5 is a diagram illustrating the effects of the data driving device to which the data masking combination logic according to an embodiment of the present disclosure is applied.

### DETAILED DESCRIPTION OF THE DISCLOSURE

The present disclosure is susceptible to various modifications and embodiments, and specific embodiments are illustrated and described in the drawings. However, this is not intended to limit the present disclosure to specific embodiments, but rather to encompass all modifications, equivalents, and alternatives falling within the spirit and scope of the present disclosure.

The suffixes “module” and “unit” used herein are used solely for nominal distinction between components and should not be construed as implying that the components are physically or chemically distinct or separated, or capable of being so distinguished or separated.

Terms containing ordinal numbers, such as “first” and “second”, may be used to describe various components, but these components are not limited by these terms. These terms may be used solely as nominal terms to distinguish one component from another, and their relative ordering is determined not by the name itself, but by the context of the description.

The term “and/or” is used to encompass any combination of multiple items the term refers to. For example, “A and/or B” means all three cases of “A”, “B”, “A and B”.

When a component is referred to as being “coupled” or “connected” to another component, it should be understood that the component may be directly coupled or connected to the other component, but that other components may also be present therebetween.

The terms used in this application are used solely to describe specific embodiments and are not intended to limit the present disclosure. Singular expressions encompass plural expressions unless the context clearly dictates otherwise. In this application, the term “comprise” or “have” is intended to indicate the presence of a feature, a number, a step, an operation, a component, a part, or a combination thereof described in the specification, but do not preclude the presence or addition of one or more other features, numbers, steps, operations, components, parts, or combinations thereof.

Unless otherwise defined, all terms, including technical or scientific terms, used herein have the same meaning as commonly understood by one of ordinary skill in the art to which the present disclosure pertains. Terms defined in commonly used dictionaries should be interpreted as having meanings consistent with their meanings in the context of the relevant technology and, unless explicitly defined herein, should not be interpreted in an idealized or overly formal sense.

Furthermore, the term “unit”, “control unit”, “control device”, or “controller” is merely a term commonly used to designate a device that controls a given function and does not imply a generic functional unit. For example, a device designated by this term may include a communication device that communicates with other controllers or sensors to control the corresponding function, a computer-readable recording medium that stores an operating system, logic instructions, and input/output information, and one or more processors that perform determination, calculation, and decision necessary to control the corresponding function.

In addition, a processor may include semiconductor integrated circuits and/or electronic components that perform one or more of comparison, determination, calculation, and decision to achieve a programmed function. For example, the processor may be any one or a combination of a computer, a microprocessor, a CPU, an ASIC, electronic circuitry, and logic circuits.

The processor may be electrically connected to a memory and may read/write data from/to the memory. The memory and the processor may be integrated or physically separate.

Hereinafter, embodiments of the present disclosure will be described in detail with reference to the accompanying drawings.

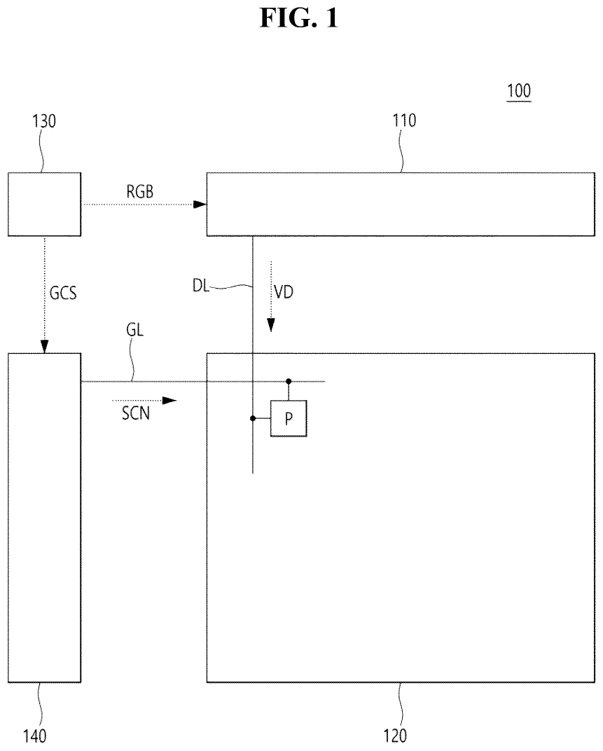

FIG. 1 is a diagram illustrating a display device configuration according to an embodiment of the present disclosure.

Referring to FIG. 1, a display driving apparatus 100 may include a display panel 120, a data processing device 130, a gate driving device 140, and a data driving device 110.

The display panel 120 may be a liquid crystal display (LCD) panel or a self-emissive panel such as an organic light emitting diode (OLED) panel.

If the display panel 120 is a liquid crystal display panel, the display panel 120 may include a backlight, liquid crystals, and a common electrode, and a pixel electrode and a driving transistor may be provided in each pixel. When a scan signal is supplied to a gate of the driving transistor, the driving transistor can be turned on, and thus a data voltage can be supplied to the pixel electrode. Then, an electric field is formed between the pixel electrode and the common electrode according to the data voltage, changing the alignment direction of the liquid crystals. Accordingly, the transmittance of light supplied from the backlight can be changed, thereby controlling the brightness of the pixel.

The display panel 120 may include a plurality of data lines DL and a plurality of gate lines GL arranged in a matrix form. The data lines DL may be connected to source terminals of the driving transistors of respective pixels, and the gate lines GL may be connected to gate terminals of the driving transistors of the pixels. When a scan signal SCN is supplied to the gate lines GL, the driving transistors are turned on, allowing a data voltage VD supplied through the data lines DL to be transmitted to the pixel electrodes.

A parasitic capacitor may be formed in each data line DL. The parasitic capacitor may be formed between the data line DL and the common electrode, or between the data line DL and the pixel electrode. From the perspective of the data driving device 110 that supplies the data voltage VD, the parasitic capacitor may be recognized as a load. The larger the capacitance of the parasitic capacitor, the more power the data driving device 110 needs to supply to the data line DL.

The display panel 120 may be a self-emissive panel, such as an OLED panel. In addition to the OLED panel, other types of self-emissive panels, such as a micro-LED panel, may be used.

Each pixel of the OLED panel may include a scan transistor, a driving transistor, and an OLED. When a scan signal SCN is supplied to the gate of the scan transistor, the scan transistor is turned on, and a data voltage VD can be supplied to the driving transistor through the scan transistor. In the OLED panel, the data voltage VD can be supplied to the gate of the driving transistor. The magnitude of the conduction current of the driving transistor is determined based on the magnitude of the data voltage VD, and the brightness of an OLED connected to the driving transistor can be controlled based on the magnitude of the conduction current of the driving transistor.

The display panel 120 may include a plurality of data lines DL and a plurality of gate lines GL arranged in a matrix form. The data lines DL may be connected to the source terminals of the scan transistors of respective pixels, and the gate lines GL may be connected to the gate terminals of the source transistors of the pixels. When a scan signal SCN is supplied to the gate lines GL, the scan transistors are turned on, allowing a data voltage VD supplied through the data lines DL to be transmitted to the driving transistors.

A parasitic capacitor may be formed in each data line DL. The parasitic capacitor may be formed between the data line DL and the cathode of an OLED, or between the data line DL and the anode of the OLED. From the perspective of the data driving device 110 that supplies the data voltage VD, the parasitic capacitor may be recognized as a load. The larger the capacitance of the parasitic capacitor, the more power the data driving device 110 needs to supply to the data line.

The data processing device 130 may receive image data from an external device, such as a host or an application processor (AP). Then, the data processing device 130 may convert the image data in a format of the external device into image data RGB in a format that can be processed by the data driving device 110. The data processing device 130 may transmit the converted image data RGB to the data driving device 110.

The image data RGB may include pixel data representing a gray scale value for each pixel P. The pixel data for one pixel P may be, for example, 8-bit data and may represent a gray scale value from 0 to 255. The data processing device 130 may generate pixel data for each pixel, include the pixel data in image data RGB and transmit the same to the data driving device 110.

The data processing device 130 may transmit control signals to devices involved in driving the display panel, such as the data driving device 110 and the gate driving device 140. The data processing device 130 may transmit a data control signal DCS to the data driving device 110 and transmit a gate control signal GCS to the gate driving device 140.

The control signals DCS and GCS may include configuration information for the data driving device 110 and the gate driving device 140. For example, the data processing device 130 may receive the configuration information from an external device, verify the configuration information for each device, include the configuration information in the relevant control signal DCS or GCS, and transmit the same.

The control signals DCS and GCS may include timing signals for controlling the devices. The timing signals may be, for example, a vertical synchronization signal Vsync, a horizontal synchronization signal Hsync, etc. The data driving device 110 or the gate driving device 140 may distinguish frames and each horizontal time according to the timing signal. In terms of controlling the timing of each device, the data processing device 130 is sometimes referred to as a timing controller.

The gate driving device 140 may supply scan signals SCN to pixels P disposed in the display panel 120. Pixels to which a scan signal SCN for turning on a pixel has been supplied may be selected, and a data voltage VD may be supplied to the selected pixels.

The gate driving device 140 may supply the scan signals SCN through the gate lines GL. The plurality of gate lines GL may be arranged on the display panel 120. The gate lines GL may be connected to pixels P arranged in a single row in one direction, for example, a horizontal direction. The gate driving device 140 may supply the scan signal SCN for instructing to turn on a pixel through one of the plurality of gate lines GL, and pixels P connected to the gate line GL may be selected. The gate driving device 140 may supply the scan signal SCN for turning on a pixel while changing the gate line GL at every horizontal time.

The data driving device 110 may drive the pixels P arranged in the display panel 120.

The data driving device 110 may receive image data RGB from the data processing device 130. Furthermore, the data driving device 110 may check pixel data for each pixel P included in the image data RGB, generate a data voltage VD corresponding to the pixel data, and supply the data voltage VD to each pixel P.

The pixel data may represent a gray scale value for each pixel P, and the data driving device 110 may generate a data voltage VD corresponding to the gray scale value.

The pixel data may be stored in a latch circuit of the data driving device 110 and then output in the form of a digital signal. Furthermore, the data driving device 110 may convert the digital signal into an analog voltage using gamma reference voltages.

There is a difference between a gray scale corresponding to physical brightness and a gray scale corresponding to brightness perceived by humans. Compensating for such a difference is referred to as gamma conversion. The data driving device 110 may simultaneously apply gamma conversion when converting a digital signal into an analog voltage. For example, the data driving device 110 can simultaneously apply digital-to-analog conversion and gamma conversion by using voltages used for digital-to-analog conversion as voltages to which gamma conversion has been applied, i.e., gamma reference voltages.

An analog voltage may not be suitable for driving a pixel P due to its low power level. Therefore, the data driving device 110 may amplify the analog voltage to generate a data voltage VD and supply the data voltage VD with a relatively high power level to the pixel P.

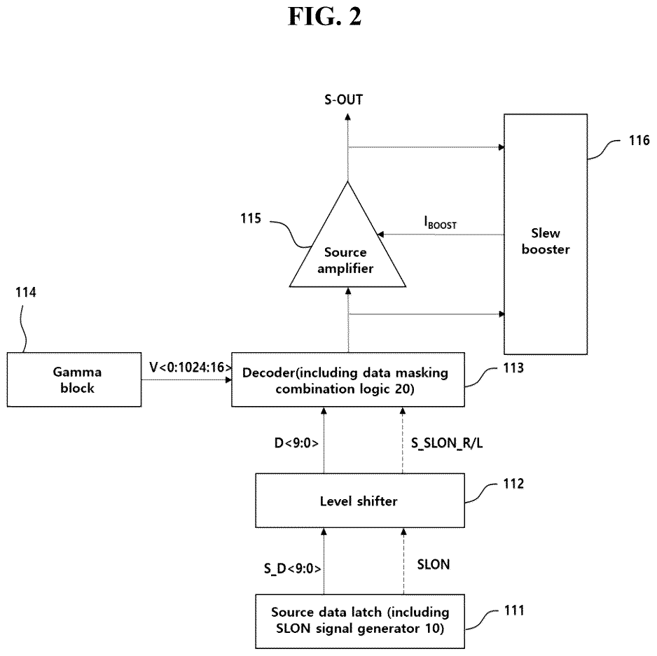

FIG. 2 is a diagram illustrating a configuration of the data driving device according to an embodiment of the present disclosure.

Referring to FIG. 2, the data driving device includes a source data latch 111, a level shifter 112, a decoder 113, a gamma block 114, a source amplifier 115, and a slew booster 116.

The source data latch 111 is a component that performs stable data storage and timing control during signal processing of the data driving device 110.

The source data latch 111 latches image data transmitted from the data processing device 130 and transmits the same to the next stage. According to an embodiment of the present disclosure, the image data may be latched by the source data latch 111 and output as 10-bit data (e.g., S_D<9:0>). The output 10-bit data is referred to as first data.

The source data latch 111 may include a SLON signal generator 10. The SLON signal generator 10 may generate a data masking pulse signal (e.g., a SLON signal). When the SLON signal passes through the level shifter 112, the SLON signal is converted into an S_SLON_R/L signal. The S_SLON_R/L signal may also be a data masking pulse signal. In an embodiment of the present disclosure, the pulse width PW of the data masking pulse signal may be adjustable in the range of 25 ns to 400 ns. A default value of the pulse width PW of the data masking pulse signal may be set to 300 ns, and this can be adjusted depending on the situation.

The source data latch 111 may output RSL, GSL, and BSL signals during a slewing time, and may output original R, G, and B data during a settling time. In the present disclosure, the slewing time is referred to as a first time T1, the settling time is referred to as a second time T2, the RSL, GSL, and BSL signals are referred to as third data, and the original Red, Green, and Blue data, i.e., R_Data[n], G_Data[n], and B_Data[n], are referred to as fourth data.

The level shifter 112 is a component that converts a voltage level received during signal processing of the data driving device 110 and transmits the same to the next stage. The level shifter 112 includes an input terminal, a voltage conversion circuit, and an output terminal.

The input terminal of the level shifter 112 may receive the first data (e.g., S_D<9:0>), which is data output from the source data latch 111, and the SLON signal, which is a data masking pulse signal.

The voltage conversion circuit of the level shifter 112 converts the voltage levels of the first data (e.g., S_D<9:0>), which is input digital data, and the data masking pulse signal (e.g., SLON signal) to adjust the voltage levels to levels required by the decoder 113. This process maintains the accuracy and stability of the digital data and prevents signal distortion. For example, if the voltage of the input data has a low level (1.2 V), the voltage conversion circuit can convert this level into a high voltage level (3.3 V) that can be accepted by the decoder 113.

The output terminal of the level shifter 112 outputs the converted data to the decoder 113, and the final output signals may be transmitted in the form of D<9:0>and S_SLON_R/L. Here, D<9:0>is a signal obtained by converting the level of the first data (e.g., S_D<9:0>), and is referred to as a second signal in the present disclosure. The S_SLON_R/L signal is a signal obtained by converting the level of the SLON signal, and may be a data masking pulse signal. The output signals may be combined in a data masking combination logic 20 in the decoder 113 to be used to prevent slew rate deviation and gray scale inversion.

The decoder 113 is a component that decodes digital data received during the signal processing of the data driving device 110 and prepares data to be output to the display panel. The decoder 113 includes a data input terminal, the data masking combination logic 20, and a DEC core 22.

The data input terminal of the decoder 113 may receive the second data (e.g., D<9:0>) output from the level shifter 112, separate the second data into upper bits (D<9:4>) and lower bits (D<3:0>), and perform data processing thereon.

The data masking combination logic 20 of the decoder 113 may control the lower bit data (e.g., D<3:0>) by using a data masking pulse signal, which is a signal generated by the SLON signal generator 10 included in the source data latch 111, thereby reducing slew deviation in an interpolation gray scale range. The data masking combination logic 20 may use an AND gate 21 to combine the lower bit data (e.g., D<3:0>) and the data masking pulse signal (e.g., S_SLON_R/L) to generate modified lower bit data (e.g., D′<3:0>).

In the source data latch 111, RSL, GSL, and BSL data for channels R, G, and B may be generated by combining the upper bits (D<9:4>) and the modified lower bits (e.g., D′<3:0>) and output during the first time T1 (slewing time). In an embodiment of the present disclosure, the RSL, GSL, and BSL data may be referred to as third data, and RSL may be represented as a combination of R_Data[9:4] and modified R_Data[3:0] controlled by the SLON signal. Obviously, GSL and BSL may also be represented in the same manner. As a result, RSL, GSL, and BSL, i.e., the third data, are output in the form of real gamma gray scale, and can prevent gray scale inversion in the interpolation gray scale range that may occur in the initial transient state (first time) T1, and can provide uniform gray scale representation.

The DEC core 22 combines the upper bits with the modified lower bits processed by the data masking combination logic 20 to generate final gray scale data, which is then transmitted to the source amplifier 115.

The gamma block 114 may generate and transmit gamma gray scale data required by the display panel 120 during the signal processing of the data driving device 110 and may be configured as a circuit including a resistor string (R-string).

The gamma block 114 may generate various types of gray scale data required by the display panel 120 based on the voltage difference between the highest voltage Vtop and the lowest voltage Vbot. In an embodiment of the present disclosure, the generated gray scale data may be expressed as a 10-bit signal, which may be separated into upper six bits and the lower four bits. The gamma block 114 may define the primary gray scale data of the display through the upper bits and finely adjust interpolation gray scale data using the lower bits.

The gamma block 114 evenly distributes the voltages between the highest voltage Vtop and the lowest voltage Vbot along the R-string, thereby generating gray scale data of V<0:1024:16>. This represents 1024 available voltage values, which can be mapped to the gray scale levels of the display panel.

The source amplifier 115 receives digital data output from the decoder 113 and converts the same into an analog signal. The source amplifier 115 may amplify the input signal to voltage and current levels appropriate for the display panel. This minimizes signal distortion during the amplification process and enables accurate gray scale expression. The source amplifier 115 may transmit the amplified signal to the pixels of the display panel, and the final output signal may determine the brightness and color of each pixel.

The slew booster 116 may be a circuit that compensates for a slew rate by supplying additional current I_{BOOST} to each channel and may be included in the source amplifier 115. The slew booster 116 compensates for a slew rate deviation between an edge channel and a center channel, thereby maintaining uniform signal quality across all channels.

The slew booster 116 may include a strength option, which may be a setting value that adjusts the current supply strength of the slew boost circuit. The slew boost strength can be adjusted according to each display environment (e.g., resolution and frame rate) to maintain optimal signal quality. For example, in high-resolution and high-frame rate environments, a higher slew boost strength may be applied to prevent signal distortion.

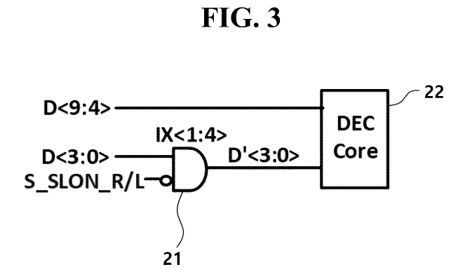

FIG. 3 is a diagram of the data masking combination logic according to an embodiment of the present disclosure.

Referring to FIG. 3, the data masking combination logic includes an AND gate and a DEC core.

The data masking combination logic 20 may process data by separating the same into upper bits (e.g., D<9:4>) and lower bits (e.g., D<3:0>). The upper bits D<9:4> contain key brightness information of gray scale data and can determine large changes in gray scale values (basic brightness levels). The lower bits D<3:0> can finely adjust the brightness level determined by the upper bits, and thus may include an interpolation gray scale bit sequence.

The S_SLON_R/L signal is a data masking pulse signal and is a timing control signal generated by the SLON signal generator 10 of the source data latch 111. This signal may control or mask the lower bits during the first time T1 (slewing time).

The AND gate 21 may generate modified lower bit data (e.g., D′<3:0>) by combining the lower bit data D<3:0> with a data masking pulse signal (e.g., S_SLON_R/L). Here, IX<1:4> is an interpolation control signal that may be used to modify or compensate the lower bit data.

The DEC core 22 combines the upper bits with the modified lower bits to generate final gray scale data. This data may be the aforementioned RSL, GSL, and BSL data, and the DEC core 22 may transmit the RSL, GSL, and BSL data to the source amplifier 115 such that the RSL, GSL, and BSL data is output to the display panel.

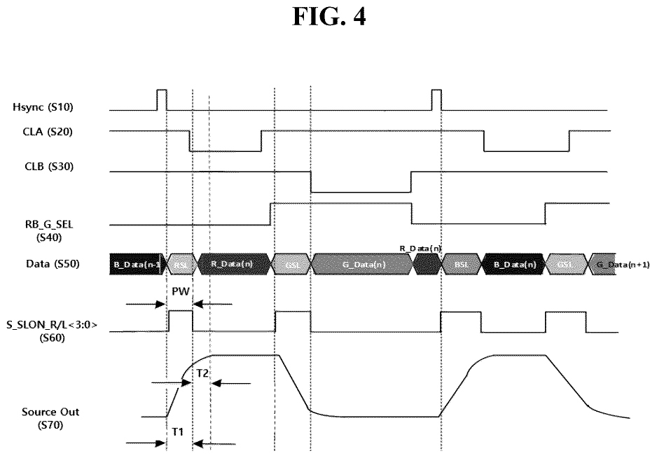

FIG. 4 is a timing diagram of the data driving device employing the data masking combination logic according to an embodiment of the present disclosure.

Referring to FIG. 4, a timing diagram of the data driving device according to an embodiment of the present disclosure includes Hsync, CLA/CLB, RB_G_SEL, data, S_SLON_R/L<3:0>, and SOURCE OUT signals. The first period includes a slewing time period, which is an initial transient time, and the second period includes a settling time period.

The Hsync signal S10 maintains horizontal synchronization of display lines and may be a reference signal for initiating data processing for each line.

The CLA/CLB signals S20 and S30 are internal clock signals for controlling the output timing of the RB_G_SEL signal S40 and the data signal S50.

The RB_G_SEL signal S40 is a selection signal between Red, Blue, and Green data, and may be a signal for determining the order of output data blocks.

As the data signal S50, data (third data) converted into RSL, GSL, and BSL signals, and R_Data[n], G_Data[n], and B_Data[n] (fourth data) may be sequentially output. RSL is calculated as RSL=R_Data[9:4]+(R_Data[3:0]+SLON), and GSL and BSL can also be calculated in the same manner. R_Data[n], G_Data[n], and B_Data[n] represent original data obtained by restoring the modified lower bits. The source data latch 111 may generate RSL, GSL, and BSL (third data), which are modified data to be used in the initial transient state (first time T1, slewing time), for respective RGB data channels, thereby preventing signal distortion that may occur in the initial transient state.

The S_SLON_R/L<3:0> signal S60 is a signal having a pulse with PW, which is used to control the data masking combination logic 20, and may control the lower bit data.

The S_SLON_R/L<3:0> signal S60 is a signal generated by the SLON signal generator 10 in the source data latch 111, and may control the lower bit data to prevent signal distortion and gray scale inversion occurring in the interpolation gray scale range. Furthermore, this signal may output real gamma gray scale data during the first time T1 (slewing time) to maintain the same load conditions across all channels. This can reduce slew rate deviation and prevent image quality distortion. The pulse width PW of the S_SLON_R/L<3:0> signal S60 may be adjusted in the range of 25 ns to 400 ns. The default value of the pulse width is set to 300 ns and may be changed depending on the situation.

The SOURCE OUT signal S70 may be a signal finally output to the display, and may output data stabilized after the first time T1 (slewing time) and the second time T2 (settling time). The first time T1 is the time before the data is stabilized from the initial transient state. During this time period, modified data, such as the third data RSL, GSL, and BSL, may be output to compensate for the slew rate. The second time T2 (settling time) may be the time after the first time T1 (slewing time) when the original data is output.

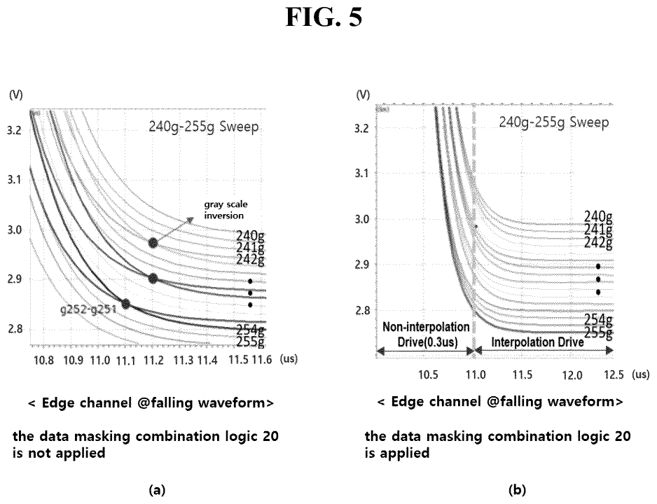

FIG. 5 is a diagram illustrating the effects of the data driving device employing the data masking combination logic according to an embodiment of the present disclosure.

Referring to FIG. 5, source output falling waveforms in a case (a) where the data masking combination logic 20 is not applied and a case (b) where the data masking combination logic 20 is applied are compared.

FIG. 5(a) shows waveforms at a falling point of the source output in an edge channel when the data masking combination logic 20 is not applied. Referring to FIG. 5(a), gray scale inversion occurs in gray scale data (Gray 240-255Sweep), and the periods (Gray 243-244, 247-248, and 251-252) indicated by dots in the graph represent periods in which voltage values are abnormally reduced or distorted.

Problems occurring when the data masking combination logic 20 is not applied include a phenomenon in which voltage changes in a high-gray scale region do not normally increase but decrease (reverse), signal distortion due to an irregular change in the slew rate in the edge channel, and deterioration of display image quality due to gray scale data that does not increase linearly.

FIG. 5(b) shows waveforms at the falling point of the source output in the edge channel when the data masking combination logic 20 is applied according to an embodiment of the present disclosure. Referring to FIG. 5(b), it can be ascertained that a non-interpolation drive period and an interpolation drive period are separate, monotonicity performance is secured for a short time (0.3 μs), and the voltage value increases linearly even in the high-gray scale region (240 to 255), and thus there is no gray scale inversion.

By applying the data masking combination logic 20, it is possible to maintain stable voltage changes in high-gray scale regions, eliminate voltage reduction, maintain a constant slew rate to minimize signal distortion even in the edge channel, and precisely control lower bit data in the interpolation gray scale range to ensure linearity of gray scale data.

According to at least one embodiment of the present disclosure, gray scale inversion and signal distortion problems that may occur during gray scale data processing can be effectively prevented.

According to at least one embodiment of the present disclosure, the present disclosure provides the technical advantages of enhancing signal stability during the initial transient state, maintaining uniform load conditions, and outputting reliable gray scale data even in high-speed environments. This enables superior quality and user experience in high-resolution and high-refresh rate displays.

The effects achieved by the present disclosure are not limited to the effects mentioned above, and other effects not mentioned will be clearly understood by those skilled in the art from the following description.

The method according to the above-described embodiment can be created as a program for execution on a computer, and the program can be stored on a computer-readable recording medium. Examples of computer-readable recording media include a ROM, a RAM, a CD-ROM, a magnetic tape, a floppy disk, optical data storage devices, and the like. It also includes a computer-readable recording medium implemented in the form of a carrier wave (e.g., transmitted via the Internet).

The computer-readable recording medium can be distributed across network-connected computer systems, allowing the computer-readable code to be stored and executed in a distributed manner. Furthermore, functional programs, codes, and code segments for implementing the above-described method can be readily inferred by programmers skilled in the art.

It will be apparent to those skilled in the art that the present disclosure can be embodied in other specific forms without departing from the spirit and essential characteristics thereof. Accordingly, the above detailed description should not be construed as limiting in all respects, but rather as illustrative. The scope of the present disclosure should be determined by a reasonable interpretation of the appended claims, and all changes coming within the equivalent scope of the present disclosure are intended to be included within the scope.

1. A data driving device for driving a display panel, comprising:
a source data latch configured to latch image data and to output first data;
a level shifter configured to receive the first data from the source data latch and to convert a level of the first data to generate second data;
a gamma block configured to decode gamma reference voltages corresponding to gray scale levels;
a decoder configured to separate the second data transmitted from the level shifter and the gamma reference voltages from the gamma block, and to separate the second data into upper bits and lower bits; and
a source amplifier configured to amplify data output from the decoder and to output the amplified data to the display panel,
wherein the decoder includes a data masking combination logic configured to control the lower bits.

2. The data driving device of claim 1, wherein the source data latch includes a SLON signal generator,
wherein the SLON signal generator generates a data masking pulse signal.

3. The data driving device of claim 1, wherein the lower bits include interpolation gray scale bits.

4. The data driving device of claim 1, wherein the data masking combination logic controls the lower bits through an AND gate.

5. The data driving device of claim 4, wherein the AND gate generates modified lower bits by combining the lower bits and data masking pulse signal.

6. The data driving device of claim 5, wherein the source data latch outputs third data during a first time,
wherein the first time includes a slewing time.

7. The data driving device of claim 5, wherein the source data latch outputs fourth data during a second time,
wherein the second time includes a settling time.

8. The data driving device of claim 6, wherein the third data includes at least one of RSL, GSL, or BSL,
wherein the RSL, GSL, and BSL correspond to red, green, and blue data, respectively, and include data generated by combining the upper bits and the modified lower bits.

9. The data driving device of claim 7, wherein the fourth data includes at least one of R_Data[n], G_Data[n], or B_Data[n],
wherein R_Data[n], G_Data[n], and B_Data[n] correspond to red, green, and blue data, respectively, and include data, which is original data, obtained by restoring the modified lower bits.

10. The data driving device of claim 2, wherein the SLON signal generator sets a pulse width of the data masking pulse signal to a range of 25 ns to 400 ns, and adjusts the pulse width based on output timing of red, green, and blue data.

11. The data driving device of claim 1, further comprising a slew booster circuit configured to supply additional current to the source amplifier to compensate for a slew rate deviation of an edge channel.

12. A display device comprising the data driving device of claim 1.
